(19) United States
(12) Patent Application Publication
(10) Pub. No.: US 2020/0126105 A1
(43) Pub. Date: Apr. 23, 2020

(54) SYSTEM AND METHOD FOR ASSISTING CUSTOMERS ACHIEVE PURCHASE GOALS

(71) Applicant: JPMorgan Chase Bank, N.A., New York, NY (US)

(72) Inventors: Ajinkya P. JOGLEKAR, Philadelphia, PA (US); Manning R. FIELD, Media, PA (US)

(21) Appl. No.: 14/790,141

(22) Filed: Jul. 2, 2015

(51) Int. Cl. G06Q 30/02; G06Q 40/00

(52) U.S. Cl. CPC G06Q 30/0222; G06Q 40/00

(57) ABSTRACT

The invention relates to a mobile device that assists a customer to reach one or more purchase goals, comprising: a memory that stores data associated with an account and a user; a microprocessor, coupled to the memory, programmed to perform the following: identify a purchase goal on the mobile device; detect a purchase made using the mobile device; based on a funding factor, calculate a funding amount for a purchase amount of the purchase; add the calculated funding amount to a funding account; determine when the funding account has reached an amount for the purchase goal; identify a customer incentive related to the purchase goal; automatically notify the customer of the purchase goal with the customer incentive; and initiate a purchase transaction for the purchase goal using the funding account.

### RELATED APPLICATIONS

The application is related to co-pending applications, U.S. application Ser. No. 14/______, (Attorney Docket No. 72167.000984, titled “System and Method for Increasing Credit Worthiness of Account Holders”), and U.S. Application Serial No. 14/______, (Attorney Docket No. 72167.000989, titled “System and Method for Implementing Payment with a Mobile Payment Device”), both filed concurrently on Jul. 2, 2015, the contents of which are incorporated herein in their entirety.

### FIELD OF THE INVENTION

The invention relates generally to a system and method for providing a customized savings plan, and more particularly to a system and method for assisting a customer save for special purchases by setting up personalized savings goals and further helping the customer stay on track.

### BACKGROUND

Traditional savings programs give customers the option to save towards a larger goal with incremental payments. However, current savings programs are rigid and fail to consider a customer's shopping preferences. Most programs merely deposit incremental amounts in an already existing general account. However, customers fail to appreciate or even recognize the savings.

These and other drawbacks currently exist.

### SUMMARY

According to one embodiment, the invention relates to a computer-implemented system and method for assisting customers achieve purchase goals. The system may include: a mobile device comprising: a memory that stores data associated with an account and a user; a microprocessor, coupled to the memory, programmed to perform the following: identify a purchase goal on the mobile device; detect a purchase made using the mobile device; based on a funding factor, calculate a funding amount for a purchase amount of the purchase; add the calculated funding amount to a funding account; determine when the funding account has reached an amount for the purchase goal; identify a customer incentive related to the purchase goal; automatically notify the customer of the purchase goal with the customer incentive; and initiate a purchase transaction for the purchase goal using the funding account.

The invention also relates to a method that may be conducted on a specially programmed computer system comprising one or more computer processors, mobile devices, electronic storage devices, and networks.

The invention also relates to a computer readable medium containing program instructions for executing a method for assisting a customer to reach one or more purchase goals, comprising the steps of: identifying a purchase goal on the mobile device; detecting a purchase made using the mobile device; based on a funding factor, calculating a funding amount for a purchase amount of the purchase; adding the calculated funding amount to a funding account; determine when the funding account has reached an amount for the purchase goal; identifying a customer incentive related to the purchase goal; automatically notifying the customer of the purchase goal with the customer incentive; and initiating a purchase transaction for the purchase goal using the funding account.

The computer implemented system, method and medium described herein can provide the advantage of helping account holders reach financial goals, according to various embodiments of the invention. Another advantage that can be provided is customer loyalty and retention due to the increased satisfaction of the account holder. The system provides a customized wish list program that is tailored to the customer's spending and savings preferences and habits. That type of experience may enhance loyalty to the financial institution much more than a conventional credit or debit card. Also, customers can receive personalized recommendations, suggestions and benefits. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram of a system for implementing a wish list feature for an account holder, according to an exemplary embodiment of the invention.

FIG. 2 is an exemplary diagram of a method for implementing a wish list feature for an account holder, according to an embodiment of the present invention.

FIG. 3 is an exemplary diagram of a method for implementing a wish list feature for an account holder, according to an embodiment of the present invention.

FIG. 4 is an exemplary screen shot illustrating a wish list feature, according to an embodiment of the present invention.

FIG. 5 is an exemplary screen shot illustrating a wish list feature, according to an embodiment of the present invention.

FIG. 6 is an exemplary screen shot illustrating a wish list feature, according to an embodiment of the present invention.

FIG. 7 is an exemplary screen shot illustrating a wish list feature, according to an embodiment of the present invention.

FIG. 8 is an exemplary screen shot illustrating a wish list feature, according to an embodiment of the present invention.

FIG. 9 is an exemplary screen shot illustrating a wish list feature, according to an embodiment of the present invention.

FIG. 10 is an exemplary screen shot illustrating a wish list feature, according to an embodiment of the present invention.

FIG. 11 is an exemplary screen shot illustrating a wish list feature, according to an embodiment of the present invention.

FIG. 12 is an exemplary screen shot illustrating a wish list feature, according to an embodiment of the present invention.

### DETAILED DESCRIPTION

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention helps a customer save for special purchases by setting up personalized savings goals and further helps the customer stay on track. An embodiment of the present invention provides rewards, such as shipping upgrades, discounts, customer assistance, customer incentives and recommendations. Once purchases have been made, an embodiment of the present invention helps a customer organize confirmation notices, tracking information, receipts and returns. The system further enables a customer to manage budgets, purchase goals, savings goals and/or other financial information.

According to an embodiment of the present invention, a wish list savings program enables a customer to save towards personal purchase goals. The customer can save with each general everyday purchase. The savings amount may be a round up factor or amount, a percentage of the purchase amount and/or other savings amount or calculation. When a purchase goal on the wish list has been reached, the customer may receive a notification along with a customized incentive, e.g., discount, percentage off, etc. The customer may view the notification and confirm the wish list purchase straight from the program.

An embodiment of the present invention is directed to linking a funding source to a payment instrument, e.g., credit card, debit card, etc. The funding source may be an account at a financial institution, and may also include a checking account, savings account, investment account, etc. The funding source may round up a transaction amount by a funding factor, e.g., round up to a nearest dollar (or other amount), percentage, variable amount, etc. to fund an account for wish list item purchases. The wish list items may include merchandise, a trip, a goal, savings, etc. The customer may then use an associated mobile application (“mobile app”) to purchase the wish list item when the wish list account reaches an appropriate amount. The mobile app may also provide customized deals and further provide customer status and tracking data.

According to an embodiment of the present invention, customers may save and purchase items from any store in a centralized online wish list. Once items are purchased, an embodiment of the present invention continues to manage the process by maintaining purchase details and tracking information. According to an embodiment of the present invention, a customer may make purchases from a wish list. For example, payment may occur straight from the wish list, or by clicking through to a third party site using a connect functionality. A customer may view and interact with upcoming potential purchases in one place and further manage spending and budgets.

According to an exemplary illustration, a customer may visit a local juice bar and purchase a juice for $5.25. An embodiment of the present invention may automatically round up the purchase to $6.00 so $0.75 may be added to the customer's wish list fund. After the purchase is complete, the customer may receive a notification on the customer's mobile device that the customer now has enough saved to purchase a product, e.g., pair of shoes, on the customer's wish list. The customer may tap (or otherwise interact) with the notification to view the customer's wish list.

During this interaction, the customer may also notice that a second item on the wish list, a new pair of sunglasses, is now 25% off. With the discount, the customer may have enough to purchase the second item. Otherwise, the customer may continue to save for the second item or purchase the second item with other forms of currency, e.g., loyalty points, store credit, gift cards, funds from other sources, including checking, savings, debit card, credit instrument, and others. The customer may then tap on both items and complete the purchase without leaving the wish list. The customer may manage wish list products, progress, purchases and returns. For example, the customer may view order confirmation details, shipping addresses, and other upgrades, e.g., a free upgrade to express shipping. The customer may receive notifications when the wish list items have arrived. For returns and exchanges, the customer may drop off packages off at a branch location, merchant store, post office or other convenient location.

In addition, as the customer makes purchases towards with list goals, the customer may view coupons, deals and/or other incentives that are tailored to the customer. Also, as the customer progresses in payments and purchases, an embodiment of the present invention may notify the customer about a new benefit, purchase opportunity, wish list recommendation, etc. For example, because the customer spends a threshold amount (in a geographic location), the customer may be considered a preferred customer at local shops and restaurants. Other customers may receive invitations to special events, access to special deals and offers and/or other benefits and privileges. For example, an embodiment of the present invention also enables customers to pre-order items, skip lines and receive discounts at local shops and businesses.

According to an embodiment of the present invention, an authentication feature may be implemented. Customer authentication may occur at checkout, at activation, during the shopping process, etc. Authentication may be provided through various mechanisms, including customer behavior or other activity. Also, authentication may be applied to purchases over a predetermined threshold (e.g., high-end, expensive purchases), unusual purchases, high number of the same product, etc. Authentications may also include fingerprint recognition, PIN, facial recognition, swipe pattern, etc. Other forms of authentication and fraud prevention mechanisms may be applied.

An embodiment of the present invention provides purchase confirmations and details on a customer's mobile device. Customers may view various forms of information. For example, spending may be organized by category, location and/or other metric. Recommendations may be provided to customers based on local spending behavior and peer trends. Also, purchase confirmations and details may be provided on the customer's mobile device. An embodiment of the present invention may also provide various benefits, including local VIP customer pass, loyal customer perks and discounts, etc.

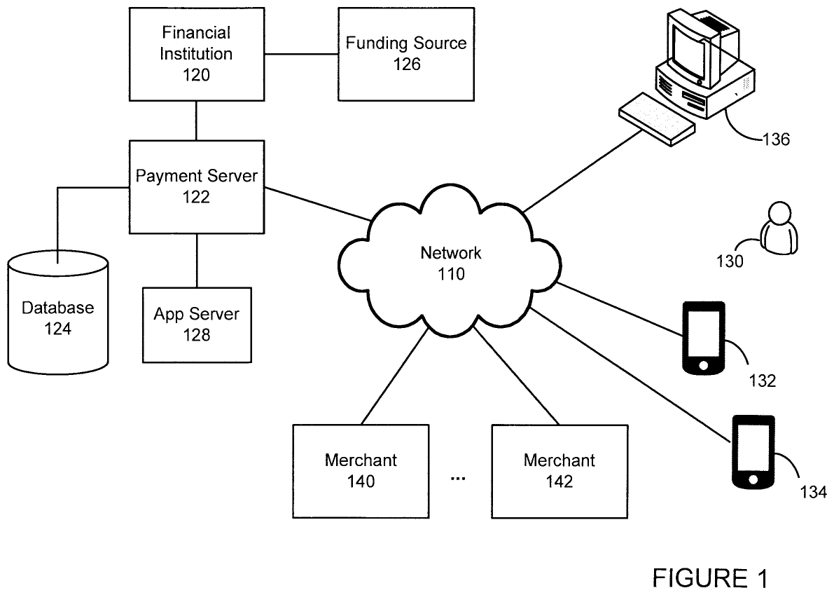

FIG. 1 is a diagram of a system for implementing a wish list feature for an account holder, according to an exemplary embodiment of the invention. As shown in FIG. 1, the system may include one or more computer servers and networks. The system may be provided by a business or entity that has access to relevant information to enhance the card holder's experience. According to one embodiment, the system is operated and maintained by a financial institution such as retail bank using, in part, data on its retail bank customers, e.g., card holders of credit and debit cards issued by the retail bank.

As shown in FIG. 1, a customer or user 130 may access a network 110 via various devices, including mobile device 132, 134, computer 136 as well as other communication and processing devices, including wearables, etc. The customer may access a mobile app or other program that runs on a mobile device, computer or other processing device that enables a customer to access a merchant program. According to an embodiment of the present invention, the customer may receive a digital card that is linked to the mobile device of the customer, as described in co-pending application U.S. patent application Ser. No. ______,

Also shown in FIG. 1 is an account holder 130 of the financial institution who may communicate electronically with a financial institution 120 using a mobile device 132, 134 and a personal computing device 136. The mobile device 132, 134 may be a smart phone, such as an Apple iPhone, Samsung Galaxy, or Amazon Fire Phone, that includes a touch screen or other interactive display. The mobile device 132, 134 may also include other hardware and software enabling them to communicate using other communication channels, such as a near field communication (NFC) signals or a Bluetooth signals. The mobile device 132, 134 also typically includes hardware and software to enable communication with a cellular network and WiFi network. The personal computing device 136 may comprise a laptop computer, tablet computer, or desktop computer, for example. The account holder 130 may use the personal computing device 136 to execute various online transactions with the financial institution 120 at home or elsewhere.

An embodiment of the present invention may be provided by various entities, such as a financial institution, service provider, merchant, etc. For example, a merchant app may be offered by a merchant, represented by Merchant 140, 142, or a third party service provider. The customer may also access a payment system provided by a financial institution 120 such as a retail bank, according to one embodiment of the invention. The payment system may be embodied primarily or entirely in a payment server 122 (which may include one or more databases represented by 124) owned and/or operated by the financial institution 120 that interfaces with a number of other servers and entities via one or more networks.

Payment server 122 enables user or account holder 130 to make payments by interfacing with other servers owned and/or operated by the financial institution 120 and/or other entities. The app server 128 may interface with other servers owned and/or operated by the financial institution. For example, payment server 122 may interface with a credit card server and associated database that stores and processes credit card transactions for credit card holders of the financial institution 120. Payment server 122 may also interface with a rewards program server and associated database that stores and processes rewards information for account holders at the financial institution 120. The foregoing description is merely one example of a configuration for such functions and is not intended to be limiting.

Various embodiments of the invention may also utilize an established payment network such as the VISA network, MasterCard network, NYCE network, or other similar network to transmit information between various entities using the system. For example, payment server 122 may use the VISA network for authorization and settlement of transactions. However, use of such established credit and debit networks is not required according to various embodiments of the invention. Payment Server 122 may be configured to use other networks for executing payment transactions and transmitting information to the cardholders, merchants, and financial institutions. Payments can be made by rendering such other payment network's digital tender on the mobile device 132, 134.

Referring again to FIG. 1, the network 110 enables communications between various computing devices and storage devices in the system. The network 110 may comprise one or more of the Internet, a wide area network (WAN), a local area network (LAN), and/or an intranet, according to various embodiments of the invention. The network 110 may also comprise, include, or interface to any one or more other communication channels or devices, such as a digital T1, T3, E1 or E3 line, a digital subscriber line (DSL) connection, an Ethernet connection, an integrated services digital network (ISDN) line, a WiFi connection, Bluetooth connection, a Wireless Application Protocol (WAP) link, a Global System for Mobile Communication (GSM) link, a Global Positioning System (GPS) link, a cellular digital packet data (CDPD) link, or a satellite communication channel, for example.

As shown in FIG. 1, a user 130 may use a mobile device 132, 134 to make purchases offered or provided by a merchant or other service or product provider. For example, the mobile device 132, 134 may include a mobile app that enables the user to make purchases. The user's ability to make purchases may be funded from a funding source 126. For example, a funding source may be funded by a financial institution in the form of points, credit and/or other metric or currency. Funding source 126 may be specific to one customer. Also, a funding source may be for a family of customers or a group of customer where points and benefits may be shared, allocated and/or distributed to the members.

Having described an example of the hardware, software, and data that can be used to run the system, an example of the method and customer experience will now be described. The method will be described primarily as an example in which a customer downloads a software application (sometimes referred to as an “app”) and uses it for accumulating points and/or making purchases. However, those skilled in the art will appreciate that the principles of the invention can be applied to related circumstances, such as where the entity providing the app is a business other than a merchant, or where the merchant app functionality is provided through a browser on the customer's mobile device rather than through a software application (app) downloaded to the customer's mobile device, and with purchases from various providers.

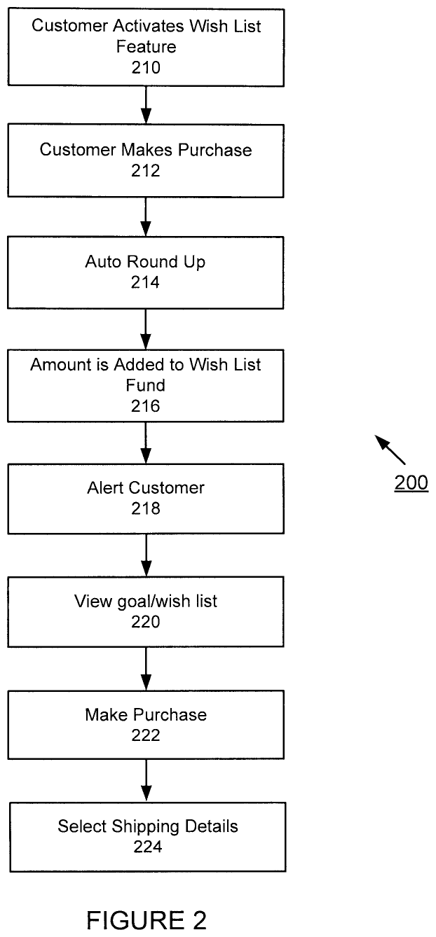

FIG. 2 is an exemplary diagram of a method for assisting a customer reach purchase goals, according to an embodiment of the present invention. At step 210, a customer may activate a wish list feature. At step 212, a customer may make a purchase. At step 214, an embodiment of the present invention may automatically round up a purchase amount of the purchase to a nearest dollar or other predetermined amount. At step 216, the additional amount may be added to a wish list fund. At step 218, an alert may be provided to the customer when the wish list fund has sufficient funds to make a purchase from the wish list. At step 220, the customer may view the wish list. At step 222, the customer may make a purchase from the wish list. At step 224, the customer may select shipping details. The order illustrated in FIG. 2 is merely exemplary. While the process of FIG. 2 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

An embodiment of the present invention actively helps a customer save for special purchases by setting up personalized savings goals and further assists the customer to stay on track. An embodiment of the present invention provides rewards, such as shipping upgrades, discounts and more. Once purchases have been made, an embodiment of the present invention helps a customer organize purchase related information, including confirmation notices, tracking information, receipts and returns. An embodiment of the present invention is directed to management functionality that allows a customer to manage budgets and/or other financial information.

At step 210, a customer may enroll or register with a wish list program. Also, the customer may be auto-enrolled with the program with a purchase or other customer action. An embodiment of the present invention may automatically enroll a customer in a wish list feature that enables the customer to automatically save towards wish list products and services. For example, if a customer is deemed to be in good standing, the customer may automatically receive this feature. Also, the customer may request or otherwise activate this feature. In addition, a store clerk may inform the customer that this option is available and activate the feature for the customer during a purchase transaction. Other variations on activation may be realized.

At step 212, a customer may make a purchase. The purchase may be made in-store at a merchant location. The customer may also make online and/or other electronic purchases. For example, the customer may make purchases using a mobile device, a merchant app, a third party app, via phone order and/or other forms of communication. A mobile app may also identify merchant locations and purchase opportunities for the customer.

An embodiment of the present invention may actively engage the customer and provide timely, relevant and tailored information. An embodiment may provide customized suggestions and/or contextual rewards, which may be based on historical data (e.g., prior purchases), brand loyalty, sale items, customer preferences, customer profile data, merchant inventory, new product programs, etc. For example, contextual offers and rewards may be based on various factors, including customer spend activity, payment activity, social media activity, customer profile, merchant data, etc.

At step 214, an embodiment of the present invention may automatically round up a purchase amount by a round up factor and/or other amount. Customers may round up purchases in various ways, including to the nearest dollar, a predetermined percentage, a predetermined amount, a fixed contribution for each purchase, variable round up amounts, percentages depending on the purchase (e.g., type of purchase, amount of purchase, timing of purchase, etc.), a customized round up or other amount or calculation. Depending on the type of contribution, the customer may view an estimated savings amount for the next 30 days or other time period. The rounding up may apply to all purchases, some purchases or qualifying purchases. Also, the amount may vary based on purchase amount, type of purchase, timing of purchase, user input, etc. For larger purchases, an embodiment of the present invention may round up to the nearest 10 dollars. For purchases under $5.00, 10 cents may be reserved for the wish list fund. For purchases that are made during a first week of the month (to coincide with when the customer gets paid at work), each transaction may be round up to the nearest $2.00, whereas for purchases made at the last week of the month, each transaction may be found up to the nearest $1.00. The customer may also indicate savings preferences. For example, if the customer wants to save more aggressively to reach a goal (e.g., time sensitive goal), an embodiment of the present invention may recommend a higher percentage of savings to the customer to reach a deadline. Other variations to accommodate a customer's financial needs or preferences as well as help customers reach their wish list goal may be applied.

At step 216, the round up amount may be added to a wish list fund or a designated account. The account may fund multiple wish list items. The round up amount may be applied in various ways. For example, a customer has been saving for 8 months for a dream summer vacation. As the summer is approaching, the customer may apply the additional amount from all purchases to the dream summer vacation and put other wish list items on hold until after the trip. Also, the additional amount may be applied to multiple accounts. The customer may designate 50% of the additional funds to a savings account and the remaining amount to the wish list fund. The customer may also have an account designated for paying off student loans. As the customer seeks to purchase a home, the customer may work towards building up his credit worthiness and pay down a credit card debt and/or other loans. Also, multiple customers may contribute to a single fund. For example, members of a family may contribute to a wish list fund. In this example, family members (e.g., parents, aunts, uncles, grandparents, etc.) may contribute to a wish list fund for a graduation gift.

At step 218, an alert may be provided to the customer when there are sufficient funds to make a purchase from the wish list. For example, a customer may review a message indicating that the current purchase has helped the customer reach a new wish list goal. The customer may also receive other types of notifications and alerts, e.g., a certain wish list item is on sale for a limited time, wish list item is on limited quantity or limited availability, delivery status of a current purchase, return status for a past purchase, etc.

For some wish list items, a customer may be alerted when a discount applies, e.g., when an item goes on sale, when the customer is close to reaching the goal, etc. For expensive wish list items (e.g., price is above a threshold amount, etc.), a split tender may be applied. In this example, a customer may apply points, funds from another account, split the cost, etc. An embodiment of the present invention may also provide ways to meet the wish list goal. For example, a wish list plan may be provided where the system provides an optimal plan so that the customer pays the least amount or nothing. In this example, the optimal plan may use loyalty points, gift cards, store credit, and/or other discounts or incentives that may apply to make the wish list item more attainable.

An embodiment of the present invention may notify the customer about wish list items, status and/or updates. The notification may be provided on a mobile device associated with the customer. For example, if the customer is accessing a mobile app, the notification may appear as a text message, in-app message, etc. If the customer is on a website, the notification may be on the website, a pop-up screen, and/or on an associated mobile or other device. The customer may be notified in multiple ways. For example, if the customer has a digital card, the digital card may display a temporary message, change colors, an icon may appear or modify, etc.

At step 220, the customer may view the wish list. The wish list may include multiple wish list items, such as merchandise, gifts, electronics, vacations, savings etc. The items may be listed based on various filters, categories, hierarchies, etc. Items that are close to being fulfilled may be displayed first. Item details, images, links, contact information and/or other information may be provided.

An embodiment of the present invention may also enable a customer to add items to the wish list. The customer may upload a photo to create a custom goal. The customer may also copy and paste a URL link. In addition, the system may suggest goals, based on profile data, prior spend data, account amount and/or other preferences and data. More specifically, the system may provide wish list recommendations based on prior wish list data, purchase history, account data, savings data, etc. For example, a customer may identify a wish list vacation at an all-inclusive resort in Mexico, an embodiment of the present invention may identify a similar vacation at the same or similar resort at a different location (e.g., Dominican Republic) that is substantially less than the Mexico vacation. By offering this wish list recommendation, the customer may opt to modify the wish list item (e.g., replace the current goal, etc.) and thereby reach the goal quicker. Wish list recommendations may also apply to merchandise, services, etc.

At step 222, the customer may make a purchase from the wish list. The customer may select a purchase option, delivery preferences and complete the wish list purchase. Before a purchasing a wish list item, a customer may be given the opportunity or option to reallocate funds to another item or other goal. For example, a customer may send a percentage of funds to a savings account or the customer may need funds for another expense, e.g., airline tickets, car repair, etc.

An embodiment of the present invention may also enable a customer to review updates, status and past purchases. For example, a customer may view updates, e.g., sales, discounts, incentives, shipping status, return status, etc. Searches, reports and/or other analysis may be performed. An embodiment of the present invention may also view categories and/or apply filters to past and/or current data. Also, peer data and/or other transaction data may be available.

At step 224, the customer may select or identify shipping details. For example, the customer may access or login to a mobile app and then choose shipping details. Also, shipping details may be predetermined based on customer profile, customer preferences, etc.

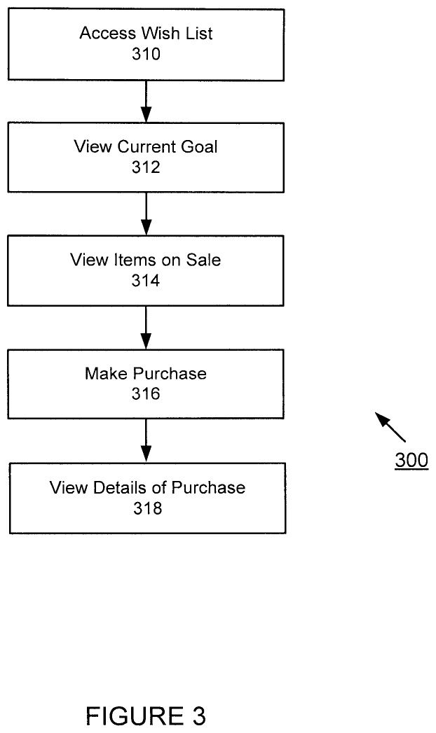

According to an exemplary method of an embodiment of the present invention, a customer may access a merchant website, select items for purchase and then proceed to a check-out. The customer may pay with the mobile app or other type of payment instrument. Depending on the customer profile, type of purchase and/or other fraud detection features, an authentication process may be applied. The amount may be charged to a payment instrument associated with the customer. The payment instrument may be a credit card, debit card, loyalty card, etc. Also, the charge may be from one or more other funding sources. Other variations may be implemented. The savings amount applied to general transactions may then be used to fund a wish list fund. Purchases made from the wish list may be implemented as illustrated in FIG. 3 below. In addition, confirmation may be provided to the customer. According to an embodiment of the present invention, a one click option may be applied. In this example, a customer may make a purchase from a merchant website where payment is made using an embodiment of the present invention.

FIG. 3 is an exemplary diagram of a method for making a wish list purchase, according to an embodiment of the present invention. At step 310, a customer may access a wish list. At step 312, the customer may view a current goal. At step 314, the customer may also view items on sale, discounted and/or other incentives. At step 316, the customer may make a purchase. At step 320, the customer may view details of the purchase. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 310, a customer may access a wish list via a mobile device or other interface. For example, a customer may view various categories of wish list items. Items may include vacations, clothing, jewelry, furniture, etc. An embodiment of the present invention enables a customer to manage wish list purchases, delivery, returns and/or other information. The customer may add wish list items, create goals, modify current items, view progress and manage the savings amount. For example, the customer may set up the savings amount, percentage, etc. for all or some transactions, categories of transactions, etc. The customer may also view estimated savings based on different savings models, inputs and factors.

At step 312, the customer may view a current goal. The customer may view a status bar (or other interactive graphic) that illustrates how close a customer is to reaching the current goal. An embodiment of the present invention may also provide an estimated number of transactions needed to reach a wish list goal. A predictive feature may be implemented to determine how soon a wish list goal can be reached. Also, a customer may view how soon the wish list goal can be reached by varying the amount or percentage to be applied to each transaction.

For example, a customer may view a selected wish list goal for jewelry. In this example, the customer may view a plan for purchase, which may include a wish list discount (e.g., 10% off plus funds), funds from the customer's wish list account, along with free shipping which means the customer currently pays no additional amount for the wish list fund.

At step 314, the customer may also view items on sale or otherwise discounted. For example, the customer may be notified when a wish list items is on low quantity, discounted, available in other colors, sizes, shapes, etc. An embodiment of the present invention may also provide other options, alternatives and/or accompanying products, services, items based on the current wish list items.

An embodiment of the present invention may provide customer status, benefits and/or other incentives. Based on the analyzed customer behavior, an embodiment of the present invention may identify tailored and customized rewards, incentives, benefits, etc. The customer may be notified of time-sensitive perks while the customer is at or near a providing merchant location.

Customized suggestions may be provided to the customer. An embodiment of the present invention may provide in-store actions, promotions, rewards, suggested products, itemized carts, cart total, etc. For example, the customer may be notified of a discount, e.g., 10% off purchase today. An embodiment of the present invention may also provide a list of suggested items, with store locations, e.g., aisle locations. The items may be from a current store, and/or multiple locations. If multiple locations are involved, an embodiment of the present invention may offer a suggested route. In a single location, an in-store route may be provided as well.

At step 316, the customer may make a purchase. The customer may select a wish list item for purchase. The customer may also invoke an automatic purchase where the item is purchased when the goal is met. This may apply to all wish list items, some or select items. Other variations may be applied.

At step 318, the customer may view details of the purchase. More specifically, the customer may perform post purchase functions, including viewing purchase confirmation, shipping details, package tracking data, etc. Post purchase functions may also enable the customer to modify shipping details (e.g., change delivery location, expedite shipping, etc.). The customer may also view goal history to view how many days it took to make the wish list purchase and how many transactions it took. The customer may also manage receipts, gift receipts, return labels, and/or other information.

The customer may run reports on wish list purchases, manage spending, make projections for future wish list purchases. For example, the customer may view and/or track shipments, returns and/or other activities. The customer may apply various filters, searches, etc. In addition, purchases may be viewed based on recent purchases, delivered, returned and/or other metric. A customer may also view and manage receipts, gift receipts, budgets, scheduled wish list goals (e.g., family member birthdays, holiday gifts, weddings, anniversaries, mother's day, father's day, etc.)

A customer may review spend activity, including total spending for a time period, e.g., day, week, month, quarter, year, etc. The customer may also view recent activity, which may be based on merchant location, time of day, amount and/or other filters and factors. The customer may view current status, attainable statuses, redeemable rewards and/or other customized messages and offers.

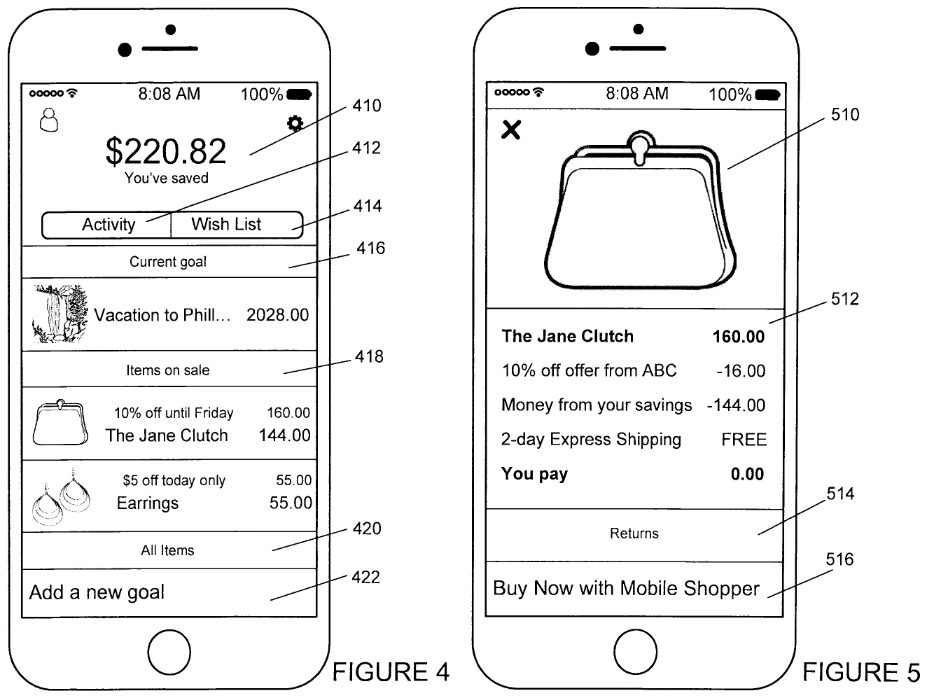

FIG. 4 is an exemplary screen shot illustrating a wish list feature, according to an embodiment of the present invention. A customer may view a current savings amount at 410. The amount may be further segmented by wish list bucket and/or other category. The customer may also view activity at 412 and wish list at 414. The customer's current wish list may be divided by categories, including current goal at 416, items on sale at 418 and all items at 420. A customer may also add a new goal at 422.

FIG. 5 is an exemplary screen shot illustrating a wish list feature, according to an embodiment of the present invention. A customer may view details of a selected wish list item. By selecting on the clutch item in FIG. 4, a customer may view a detail page shown by FIG. 5. In this example, an image of the item may be shown at 510. The image may be interactive and may also include animation, customer reviews, video, and/or other information. An embodiment of the present invention may display a plan illustrating how the customer can purchase the item. In this example, the wish list item price is shown, a customized offer may be applied along with funds from the wish list fund. Also, additional funds may be applied, including loyalty points, store credit, any additional savings, promotions, etc. A customer may also view data concerning returns at 514, including return instructions, customer comments about the return process, why the product was returned, etc. The customer may purchase the wish list item by selecting 516.

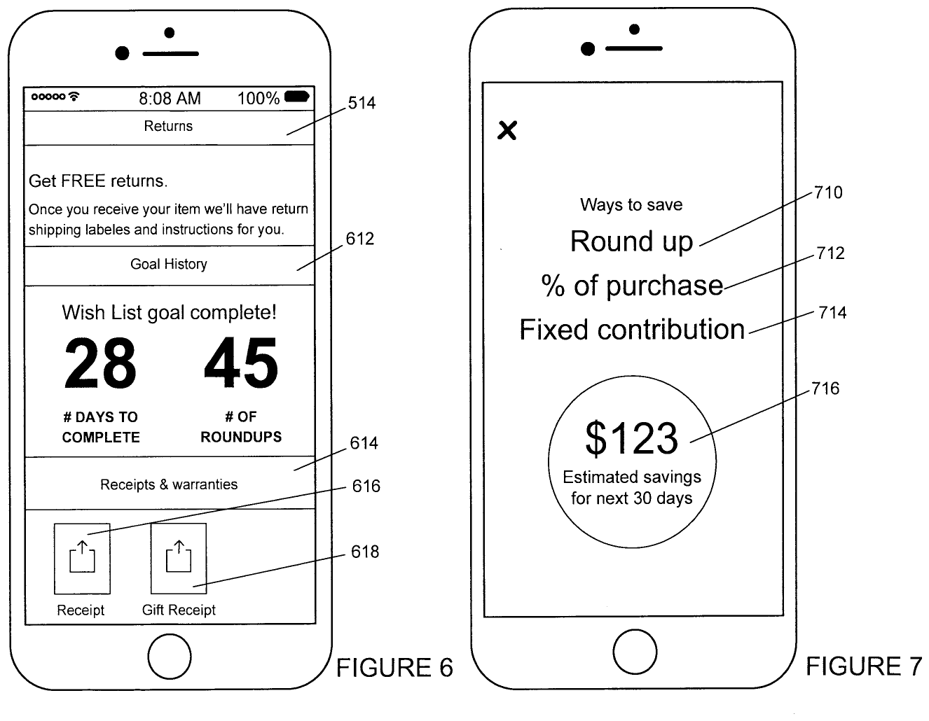

FIG. 6 is an exemplary screen shot illustrating a wish list feature, according to an embodiment of the present invention. The customer may also view goal history information at 612. In this example, the wish list goal has been completed. To reach the current goal, the customer took 28 days to complete and 45 round up transactions. Receipts and warranties data may be available at 614, where the customer may manage receipts at 616 and gift receipts at 618. Other information, including incentives, savings, and budget may also be made available.

FIG. 7 is an exemplary screen shot illustrating a wish list feature, according to an embodiment of the present invention. A customer may identify a savings method by selecting an option, including round up at 710, percentage of purchase at 712, fixed contribution at 714. The customer may also apply a customized savings plan. The system may also provide an estimate savings for a time period, e.g., next 30 days. The estimation may be based on prior spending history, type of purchase goals, time or season, life events, etc. In addition, the customer may want to reach a purchase goal by a certain date (e.g., birthday, anniversary, graduation, etc.) or time period, e.g., in 3 months. Accordingly, an embodiment of the present invention may suggest a recommended plan, the plan my further consider customer behavior, customer activity and/or other data.

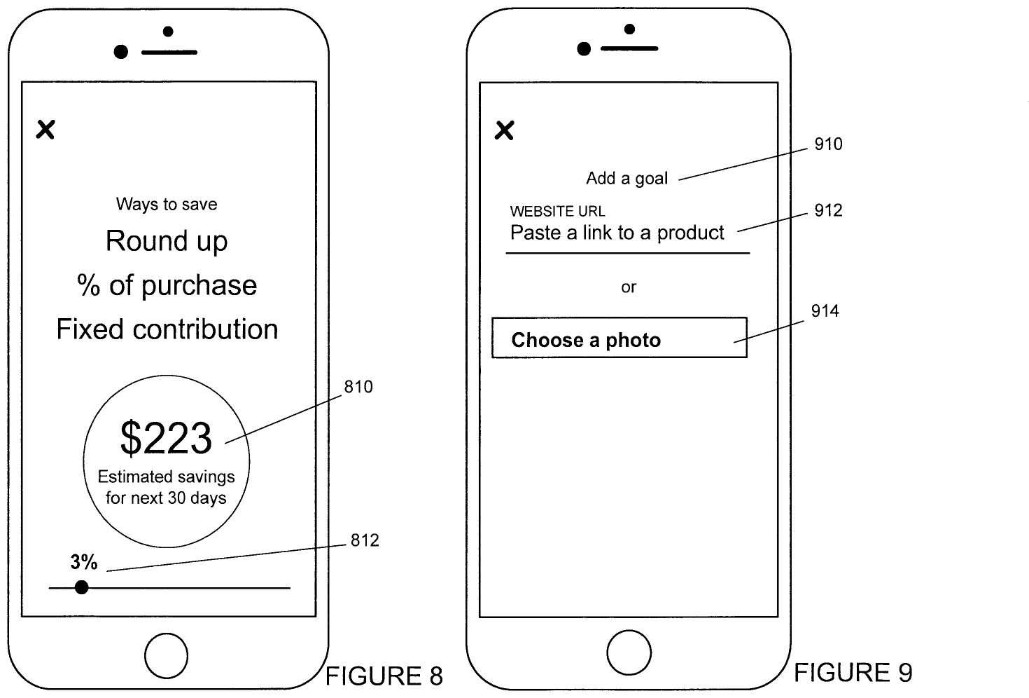

FIG. 8 is an exemplary screen shot illustrating a wish list feature, according to an embodiment of the present invention. According to another example, the customer may select and compare different ways to save and then identify a preferred method. In this example, the customer has selected a percentage of savings, e.g., 3%, as shown by a graphic 812. In this example, a sliding bar is shown. Other graphics, interactive icons, etc. may be used. As compared to the example in FIG. 7, this customer can earn more by saving 3% of each transaction, as shown by 810.

FIG. 9 is an exemplary screen shot illustrating a wish list feature, according to an embodiment of the present invention. In this example, a customer may add a new wish list goal, as shown by 910. The customer may add a goal by attaching a link at 912. The customer may also choose a photo, image or other graphic at 914. An embodiment of the present invention may update the wish list item with additional information, customer reviews, animations, instructions, etc. The system may also identify other vendors or third parties who are offering the same or comparable item for less. The customer may modify existing goals. In addition, the system may automatically update, modify goals based on user preferences, merchant availability, etc.

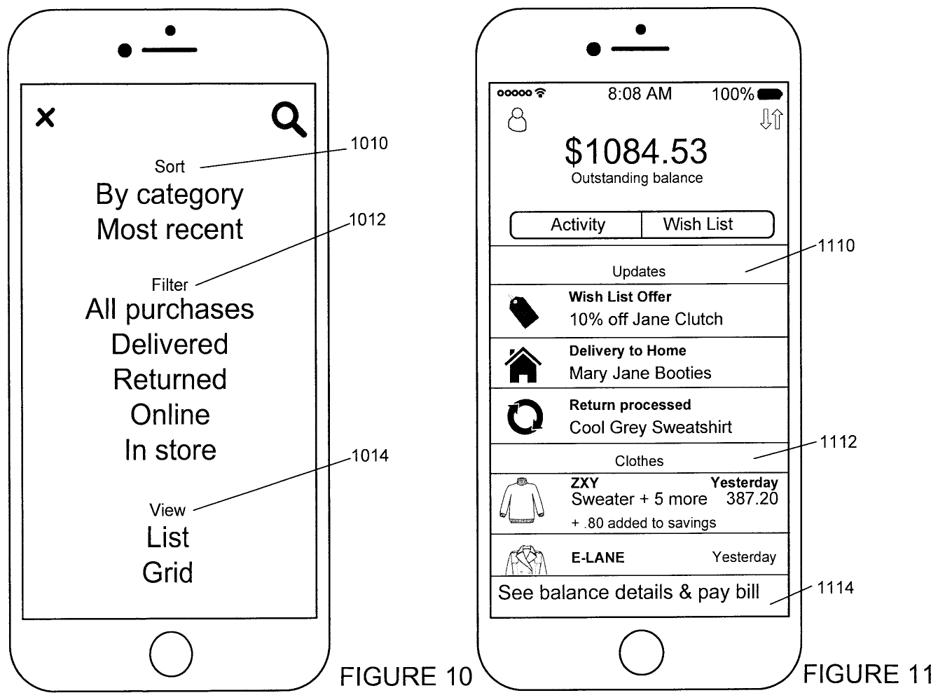

FIG. 10 is an exemplary screen shot illustrating a wish list feature, according to an embodiment of the present invention. A customer may sort 1010, filter 1012 and view 1014 data including transactions, savings and/or other information. For example, the customer may sort data by category, most recent, etc. The customer may filter data by all purchases, delivered, returned, online, in-store, etc. The customer may view the information on a list format, grid format and/or other format.

FIG. 11 is an exemplary screen shot illustrating a wish list feature, according to an embodiment of the present invention. The customer may view updates to wish list items, including current items, items being delivered, and return status, at 1110. The customer may also view categories of current items, as shown by 1112. The customer may view balance details, pay bills and/or perform other actions, at 1114.

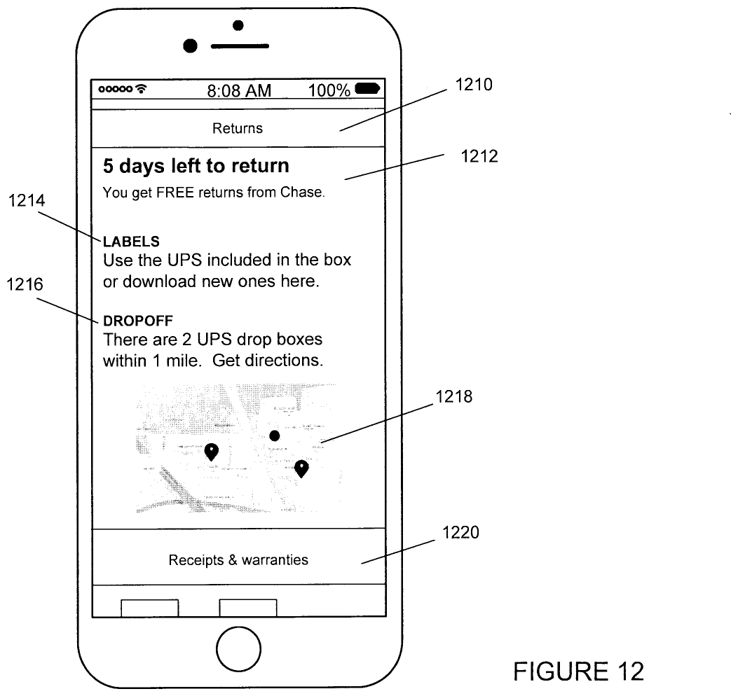

FIG. 12 is an exemplary screen shot illustrating a wish list feature, according to an embodiment of the present invention. FIG. 12 illustrates a returns page at 1210 where the customer is reminded of the return deadline at 1212. If the customer wants to return an item, the customer may obtain a label at 1214 and view drop off instructions and options at 1216. The customer may also manage receipts and warranties at 1220.

Although the foregoing description has focused primarily on a financial institution assembling relevant data sets, processing the data, and sending the relevant data at appropriate times to its customer, the system may be operated and maintained by other types of commercial entities who may configure the system to provide similar advantages to their customers. In additional, while the foregoing description has focused primarily on the customer spend, the principles of the invention can be applied to other vendors and entities where the operating entity can assemble and provide relevant, timely information to enhance the customer's experience.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Data and information maintained by the servers shown by FIG. 1 may be stored and cataloged in one or more databases, which may comprise or interface with a searchable database and/or a cloud database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

Communications network, e.g., 110 in FIG. 1, may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Communications network, e.g., 110 in FIG. 1, may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 110 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network, e.g., 110, may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication network 110 may comprise a Personal Branch Exchange (PBX), which may further connect to the PSTN.

Although examples of a mobile device 132, 134 and a personal computing device 136 are shown in FIG. 1, exemplary embodiments of the invention may utilize other types of communication devices whereby a user may interact with a network that transmits and delivers data and information used by the various systems and methods described herein. The mobile device and personal computing device may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The mobile device and personal computing device may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The mobile device and personal computing device may also include a network-enabled appliance or another TCP/IP client or other device. The mobile device 132, 134 and personal computing device 136 may include various connections such as a cell phone connection, WiFi connection, Bluetooth connection, satellite network connection, and/or near field communication (NFC) connection, for example.

As described above, FIG. 1 includes a number of servers 122, 128 and user communication devices 132, 134, 136, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, RUM Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices 132, 134 or personal computing device 136. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A mobile device that assists a customer to reach one or more purchase goals, the mobile device comprising:
a memory that stores data associated with an account and a user;
a display that displays an interactive user interface;
a microprocessor, coupled to the memory and display, programmed to perform the following:
receive, via the interactive user interface, a selection of a plurality of purchase goals from a plurality of different merchants;
display, via the interactive user interface, a plurality of interactive panels comprising an activity view, a wishlist view, a current goal panel that identifies the plurality of purchase goals, an items on sale panel that identifies current incentives including discounts and deals for relevant purchase goals, wherein the interactive user interface further provides a goal history that identifies a measure of days and transactions to reach a selected goal;
detect a purchase made using the mobile device;
based on a funding factor, calculate a funding amount for a purchase amount of the purchase, wherein the funding factor is selected from a group comprising a round up, a percentage of purchase and a fixed contribution, and further calculate an estimated savings for a time period based at least in part on customer spending history;
add the calculated funding amount to a funding account, wherein the funding account is a savings account provided by a financial institution;
determine when the funding account has reached an amount at least equal to at least one of the plurality of purchase goals, wherein the funding amount further comprises loyalty points;
identify a customer incentive, from the current incentives, related to the at least one purchase goal, wherein the customer incentive comprises one or more of loyalty points, store credit, and sales pricing;
automatically notify the customer of the customer incentive to be applied towards the at least one purchase goal;
receive, through the interactive user interface, a selection of at least one of the plurality of purchase goals for purchase based on content displayed in the plurality of interactive panels; and
initiate a purchase transaction for the selection of at least one of the plurality of purchase goals using the funding account and applying the customer incentive, wherein the purchase transaction further uses the loyalty points to make the purchase of the at least one purchase goal.

2. The mobile device of claim 1, wherein the funding factor is a percentage of the purchase amount.

3. The mobile device of claim 1, wherein the funding factor rounds up the funding amount to a nearest dollar of the purchase amount.

4. The mobile device of claim 1, wherein the funding factor is a variable amount that depends on the detected purchase.

5. The mobile device of claim 1, wherein the purchase goal comprises a customer selected merchandise.

6. The mobile device of claim 1, wherein the customer incentive comprises a predetermined discount specific to the customer.

7. (canceled)

8. The mobile device of claim 1, wherein the customer is notified by an electronic message displayed on the mobile device.

9. (canceled)

10. The mobile device of claim 1, wherein the purchase transaction for the purchase goal is initiated automatically.

11. A non-transitory computer readable medium containing program instructions for assisting a customer to reach one or more purchase goals, wherein execution of the program instructions by one or more processors of a computer system causes the one or more processors to carry out the steps of:
receiving a selection of a plurality of purchase goals from a plurality of different merchants on the mobile device;
displaying, via the interactive user interface, a plurality of interactive panels comprising an activity view, a wishlist view, a current goal panel that identifies the plurality of purchase goals, an items on sale panel that identifies current incentives including discounts and deals for relevant purchase goals, wherein the interactive user interface further provides a goal history that identifies a measure of days and transactions to reach a selected goal;
detecting a purchase made using the mobile device;
based on a funding factor, calculating a funding amount for a purchase amount of the purchase, wherein the funding factor is selected from a group comprising a round up, a percentage of purchase and a fixed contribution, and further calculate an estimated savings for a time period based at least in part on customer spending history;
adding the calculated funding amount to a funding account, wherein the funding account is a savings account provided by a financial institution;
determining when the funding account has reached an amount at least equal to at least one of the plurality of purchase goals, wherein the funding amount further comprises loyalty points;
identifying a customer incentive, from the current incentives, related to the at least one purchase goal, wherein the customer incentive comprises one or more of loyalty points, store credit, and sales pricing;
automatically notifying the customer of the customer incentive to be applied towards the at least one purchase goal;
receiving, through the interactive user interface, a selection of at least one of the plurality of purchase goals for purchase based on content displayed in the plurality of interactive panels; and
initiating a purchase transaction for the purchase goal using the funding account and applying the customer incentive, wherein the purchase transaction further uses the loyalty points to make the purchase of the at least one purchase goal.

12. The computer readable medium of claim 11, wherein the funding factor is a percentage of the purchase amount.

13. The computer readable medium of claim 11, wherein the funding factor rounds up the funding amount to a nearest dollar of the purchase amount.

14. The computer readable medium of claim 11, wherein the funding factor is a variable amount that depends on the detected purchase.

15. The computer readable medium of claim 11, wherein the purchase goal comprises a customer selected merchandise.

16. The computer readable medium of claim 11, wherein the customer incentive comprises a predetermined discount specific to the customer.

17. (canceled)

18. The computer readable medium of claim 11, wherein the customer is notified by an electronic message displayed on the mobile device.

19. (canceled)

20. The computer readable medium of claim 11, wherein the purchase transaction for the purchase goal is initiated automatically.
